(19) United States
(12) Patent Application Publication
(10) Pub. No.: US 2009/0006668 A1
(43) Pub. Date: Jan. 1, 2009

(54) Performing direct data transactions with a cache memory

(76) Inventors: Anil Vasudevan, Portland, OR (US); Sujoy Sen, Portland, OR (US); Partha Sarangam, Portland, OR (US); Ram Huggahalli, Mesa, AZ (US)

Correspondence Address: TROP PRUNER & HU, PC, 1616 S. VOSS ROAD, SUITE 750, HOUSTON, TX, 77057-2631, US

(21) Appl. No.: 11/823,519

(22) Filed: Jun. 28, 2007

(51) Int. Cl. G06F 13/00

(52) U.S. Cl. 710/33

(57) ABSTRACT

In one embodiment, the present invention includes a method for receiving data from a producer input/output device in a cache associated with a consumer without writing the data to a memory coupled to the consumer and storing the data in a cache buffer until ownership of the data is obtained, and then storing the data in a cache line of the cache. Other embodiments are described and claimed.

### BACKGROUND

In some computer systems, the performance of a processor can be judged by the ability of the processor to process data on high speed network traffic from multiple sources. Although the speed of the processor is an important factor, the performance of the processor and system also depends on factors such as how fast real-time incoming data from external components is transferred to the processor and how fast the processor and system prepares outgoing data.

In some systems, real-time data may be held in a memory device externally from the processor. Processing this data requires the processor to access the data from memory, which introduces latencies since the memory subsystem generally runs slower as compared to the processor subsystem. Improving latency can improve overall system performance.

### BRIEF DESCRIPTION OF THE DRAWINGS

FIG. 1 is a block diagram of a system implementing transactions in accordance with an embodiment of the present invention.

FIG. 2 is a transaction flow of a direct write transaction in accordance with one embodiment.

FIG. 3 is a transaction flow of a direct read transaction in accordance with one embodiment.

FIG. 4 is a block diagram of a multiprocessor system in accordance with an embodiment of the present invention.

### DETAILED DESCRIPTION

In various embodiments, communication of data between a first component such as a processor and an input/output (I/O) device such as a network adapter may be controlled to reduce latency, increase throughput, reduce power and improve platform efficiency for data transfers to and from the I/O device. Such communications may be referred to as direct I/O (DIO) communications to denote a direct path from I/O device to a cache memory, without intervening storage in memory such as a dynamic random access memory (DRAM) system memory or similar components. To achieve such benefits, data transfers may operate entirely out of cache for both inbound and outbound data transfers. Embodiments may further explicitly invalidate cache lines that are used for transient data movement to thereby minimize writeback trips to memory.

Memory bandwidth savings may also imply savings in bandwidth across a system interconnect such as a common system interface (CSI), for example. If data does not have to be read from or written to memory and if a home agent for a memory address is in a different socket, then interconnect bandwidth does not have to be consumed. A home agent refers to a device that provides resources for a caching agent to access memory and, based on requests from the caching agent, can resolve conflicts, maintain ordering and the like. Thus the home agent is the agent responsible for keeping track of references to an identified portion of a physical memory associated with, e.g., an integrated memory controller of the home agent. A caching agent is generally a cache controller associated with a cache memory that is adapted to route memory requests to the home agent.

Embodiments may be applicable to shared, coherent memory and write-back (WB) memory type data structures that are used by I/O devices and processor cores for most of their communication without the need for special memory types or specialized hardware storage mechanisms. Note that embodiments may be applicable to any producer-consumer data transfers. A producer is an agent that is a generator of data to be later accessed or used by that or another agent, while a consumer is an agent that is to use data of a producer. In various embodiments, producers and consumers may be any of processor cores, on-die or off-die accelerators, on-die or off-die I/O devices or so forth.

Referring now to Table 1, shown are descriptions of platform protocols in accordance with one embodiment.

TABLE 1

| Ingredient | Function |
|---|---|
| DIO Write Transaction | Write data from IO device to a target |
| | processor's last level cache (LLC) without |
| | memory transactions. |
| DIO Read Transaction | Read data by IO device such that data is |
| | maintained on a target processor, without |
| | memory transactions. |
| CLINVD instruction | A user-level instruction that invalidates a cache |
| (no writeback) | line without writing back data to memory; used |
| | for transient data. |

These protocols may form a group of primitives that permits producers and consumers to manage data within caches without touching memory.

As shown in Table 1, in various embodiments a DIO write transaction causes data to land in the LLC in the modified (M) state of, e.g., a modified, exclusive, shared, invalid (MESI) protocol, without being written into memory. In other embodiments, such data may land in the “E” state, which would cause one write, sill saving one trip to memory. The processor allocates a cache line in the LLC if it does not exist for the address to which the I/O device is writing. The system is fully coherent with respect to these writes. Also shown in Table 1 is a DIO write transaction, which may also avoid memory transactions. Note that in some implementations with the DIO read transaction, speculative memory reads to a memory controller on inbound I/O memory read requests are not performed, since there is a high likelihood of this data being sourced from the processor's caches. As further shown in Table 1, using a CLINVD instruction, even if the specified cache line is in the “M” state of the MESI protocol no writeback to memory may occur. Optionally, this instruction can be combined with other operations such as regular move operations.

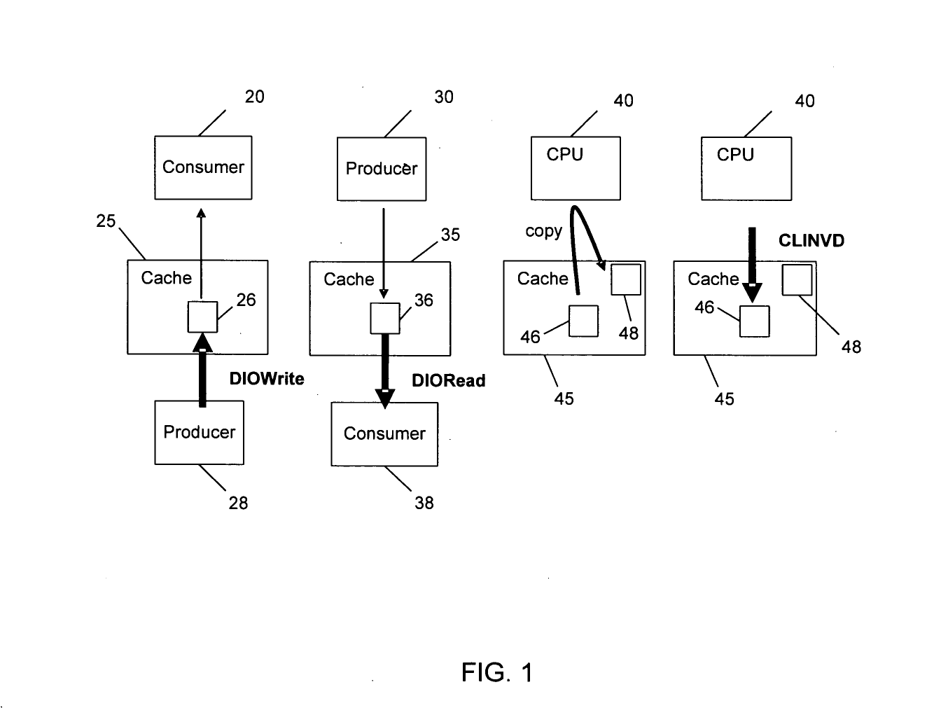

FIG. 1 shows a block diagram of a system which can perform DIO transactions in accordance with one embodiment of the present invention. As shown in FIG. 1, a system may include various components to enable DIO operations in accordance with an embodiment of the present invention. For example, a DIO write transaction may be performed between a producer 28, which may be a network interface component or other such I/O component and a cache 25 associated with a consumer 20, which may be a processor. Examples of such I/O components include media cards such as audio cards, video cards, graphics cards, and communication cards to receive and transmit data via wireless media. Other examples may include host bus adapters (HBAs) such as PCI Express™ host bus adapters, host channel adapters (HCAs) such as PCI Express™ host channel adapters, network interface cards (NICs), such as token ring NICs and Ethernet NICs and so forth.

As shown in FIG. 1, a DIO write transaction may cause data to be directly written to cache 25 and more specifically to a data block 26 within cache memory 25. By this direct write transaction, memory associated with consumer 20, such as a system memory is not touched. FIG. 1 further shows an example of a direct I/O read transaction in which a snapshot of data stored in a cache 35 (i.e., data block 36) is directly read by a consumer 38. Again, note that the transaction occurs between cache 35 and consumer 38 directly, without touching memory associated with a producer 30, which may be a processor or other such component.

Referring still to FIG. 1, another type of direct transaction may cause a copy operation to be performed in cache 45 such that a data block 46 is copied to a second location such as a buffer 48, also within cache 45. In one embodiment, a processor 40 may cause this copy operation to be performed. Processor 40 thus consumes data placed in an application-owned buffer (e.g., buffer 48) copied from data block 46 which may also be a memory buffer for the data placed there by a producer. A CLINVD instruction can then be used to invalidate data block 46 without a writeback to memory.

For inbound I/O data writes, a so-called direct I/O write (DIOWrite) transaction enables the inbound I/O write to target a processor's caches without going to memory. Data from the inbound write may be put into the processor's caches in the “M” state of a MESI protocol. This ensures that the data is consistent in the memory hierarchy. For the common case, where this data is copied into an application buffer, this saves one trip to memory. In conjunction with a CLINVD operation if this data is considered transient, it can be invalidated without a writeback, thus potentially saving two trips in memory, assuming that the “M” state line is eventually written to memory.

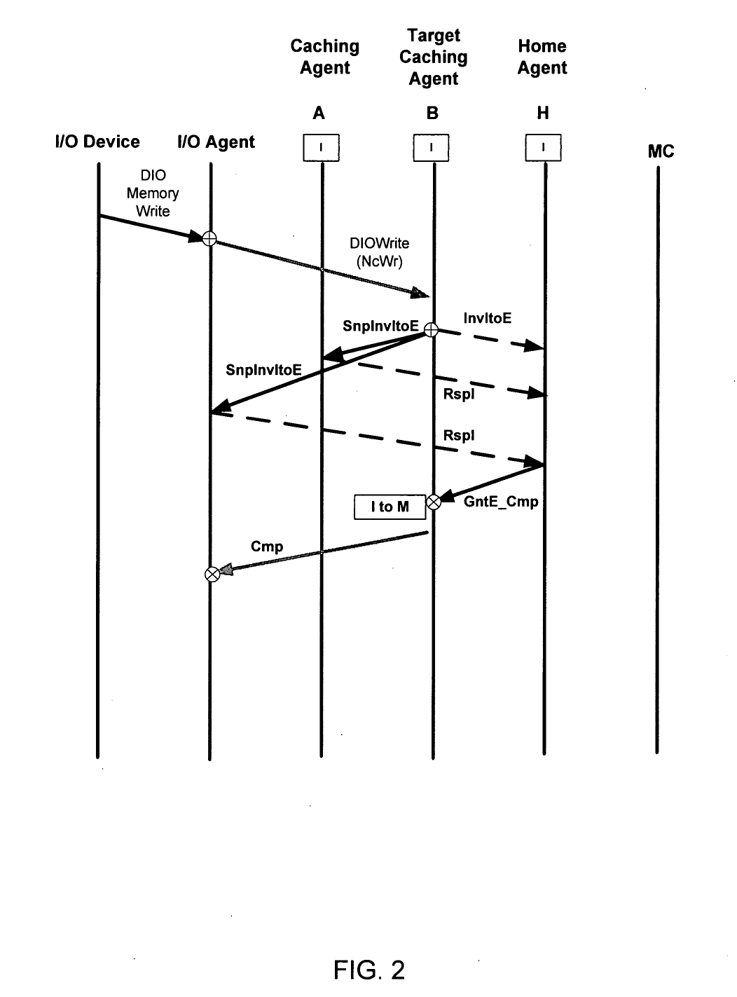

Referring now to FIG. 2, shown is a transaction flow of a direct write transaction in accordance with one embodiment. In this flow, the data is transferred by the I/O agent (of an I/O device) to an agent that contains and owns the target cache for the data (i.e. the target caching agent) as a DIO memory write transaction. This data transfer by the I/O agent may be accomplished in a non-coherent form, i.e., the data is not visible yet to any caching agent. Once the data reaches the target caching agent, the target caching agent holds the data in a temporary buffer until it gains ownership of the cache line by issuing a given snoop transaction such as invalidate-to-exclusive snoop (‘InvItoE’) flows to other agents. In this process, the caching agent also allocates a cache line within the target cache, and receiving a response to place the data into the “M” state. Thus after gaining ownership by way of the snoops and responses, the caching agent simply deposits data into the cache line of the cache in a manner similar to how a processor writes data into its caches. This method eliminates the need for a processor agent such as a core or a prefetcher to read the data. In addition, since the I/O agent transfers its data as a non-coherent message, the non-coherent message does not use memory addresses as a method of routing data. A similar method could be applied with a coherent message as well. Instead it may use a target caching agent identifier such as a processor's advanced programmable interrupt controller identifier (APICId) for routing. The message however contains the memory address and the data that is eventually transferred to the coherent domain and placed in the cache in the M state, with a completion (CMP) message sent back to the I/O agent.

In another implementation, a direct write transaction may be used to place data into a caching agent without prior knowledge of the identification of a caching agent that already includes a copy of the line. In this variant, the DIO memory write transaction from the I/O device may cause the I/O agent to send out snoops to determine where the line is present. Then, the DIO write transaction as represented in FIG. 2 may be performed. However, note that the subsequent snoops from the target caching agent need not be performed, as when the DIO write data is provided to the target caching agent, it may be directly stored therein without the need for snoops. Accordingly, the data may be stored in a given line in target caching agent B in the M state.

For inbound data reads, a so-called Direct I/O read (DIO Read) transaction enables an inbound I/O write to target a processor's caches without going to memory. A DIORead operation enables an inbound data read operation to get a snapshot of the current data, wherever it happens to be in the memory hierarchy, without changing its state. For example, if the data is in the “M” state in a particular processor's cache, the data is returned to the requester without causing a cache invalidate, leaving the eviction to the processor's least recently used (LRU) policy. Also, speculative reads are avoided, because in many of the common usage models when data is in the processor's caches, a read is issued to the memory controller only if the results from snooping indicates a miss.

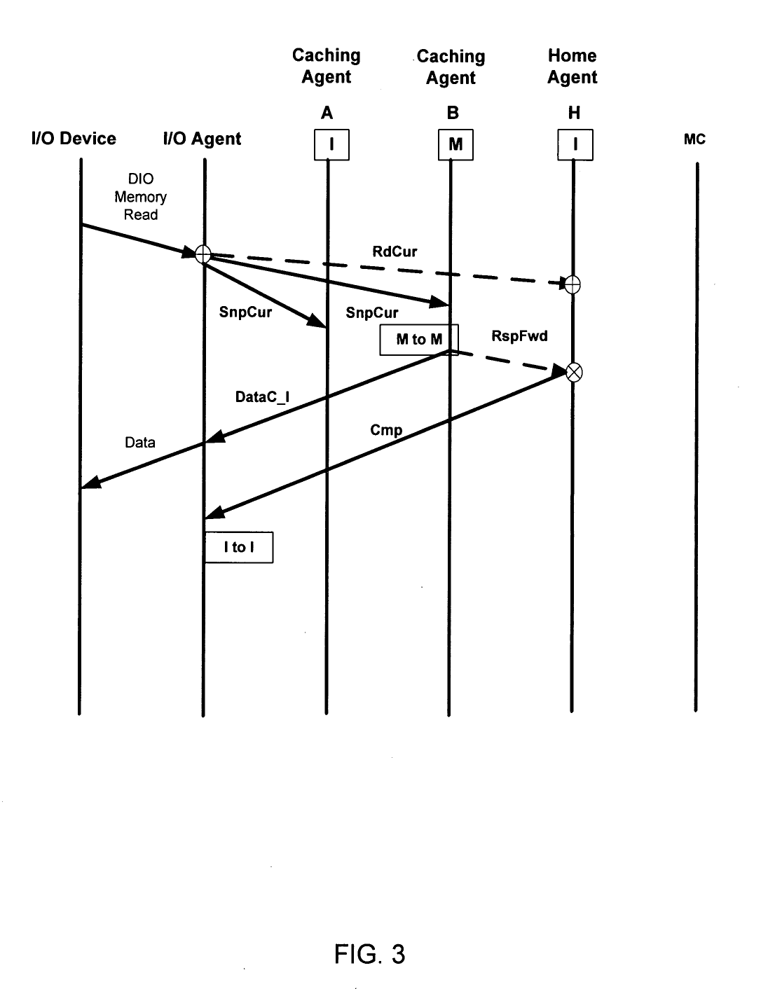

FIG. 3 shows a transaction flow for a DIORead operation in accordance with one embodiment. As shown in FIG. 3, a memory read by the I/O device (tagged specifically as a DIORead transaction, rather than a memory read (MRd) transaction) triggers a transaction to obtain a snapshot of the requested data, such as a ReadCurrent (RdCur) transaction, which obtains a snapshot of the current contents in the cache without changing the state of the line. Thus, caching agent B would not have to evict the line to memory and can retain the cache line in the “M” state (or any other state). Optionally, in the case of a DIORead transaction, the RdCur transaction may be tagged so that there is no speculative memory read. The memory controller of the home agent would hold on to the read transaction until all snoop responses are received responsive to snoop requests, and then the data is forwarded to the I/O agent (e.g., by caching agent B, as shown in FIG. 3). If the snoop responses did not result in data being forwarded to the I/O agent by a caching agent, then the home agent would go ahead to issue the memory read transaction and retrieve data from memory. Thus as shown in FIG. 3, both a memory read and a memory write transaction can be avoided by the DIORead flow.

In one variant of the DIO read transaction flow shown in FIG. 3, along with the data that is returned to the I/O device, an indication of where the data came from may also be provided. For example, with regard to the transaction flow of FIG. 3, in addition to the data completion that provides the data back to the I/O device, a portion of that message may further include an identification of caching agent B.

To mitigate the detrimental impact of cache pollution, embodiments may use a cache line invalidation operation. In general, with I/O related data movement there can be a considerable amount of transient data that is brought into a processor's caches, resulting in cache pollution. In addition, it also affects LRU policies regarding victim selection; ideally, data that is deemed transient should be preferred in victim selection after it has been operated upon. Still further, additional memory and system bus bandwidth is consumed for data that is modified and transient, e.g., cache eviction of lines written to by DIOWrites that are moved into destination buffers.

Accordingly, to avoid such ill effects, embodiments may use a user level instruction of an instruction set architecture (ISA) such as a CLINVD instruction to invalidate cache lines without writebacks to memory, even if the cache line is in the modified state. This saves memory and system bus bandwidth, and provides a means to manage (or trigger hints to) a cache LRU algorithm. The cache lines that are invalidated are available earlier than when the LRU would otherwise have made them available to be replaced. The use of this instruction thus may act as a hint to the cache LRU to put this line as the least recently used, making it available for victim selection.

Embodiments thus may consume lower memory bandwidth, reduce processor read latency (since data structures remain in cache), and consume lower system bus bandwidth and power. In this way, an I/O device may selectively control inbound and outbound data transfers from caches. That is, I/O data transfers may occur in and out of caches, allowing for software executing on the processor to operate at cache bandwidths and speeds as opposed to memory bandwidths and speeds. Furthermore, embodiments may bypass or minimize trips to memory for I/O-related data transfers by operating directly out of caches.

For more complete savings in memory bandwidth, the granularity of data transfers may be in terms of full cache lines. That is, a block of inbound data is mapped to an integer multiple of cache lines. Partial cache line transfers may incur memory accesses. Software and I/O device hardware may be optimized to re-size and align data structures to avoid partial cache line usage. With such optimizations, avoiding all memory accesses involved in I/O and processor communications may be possible.

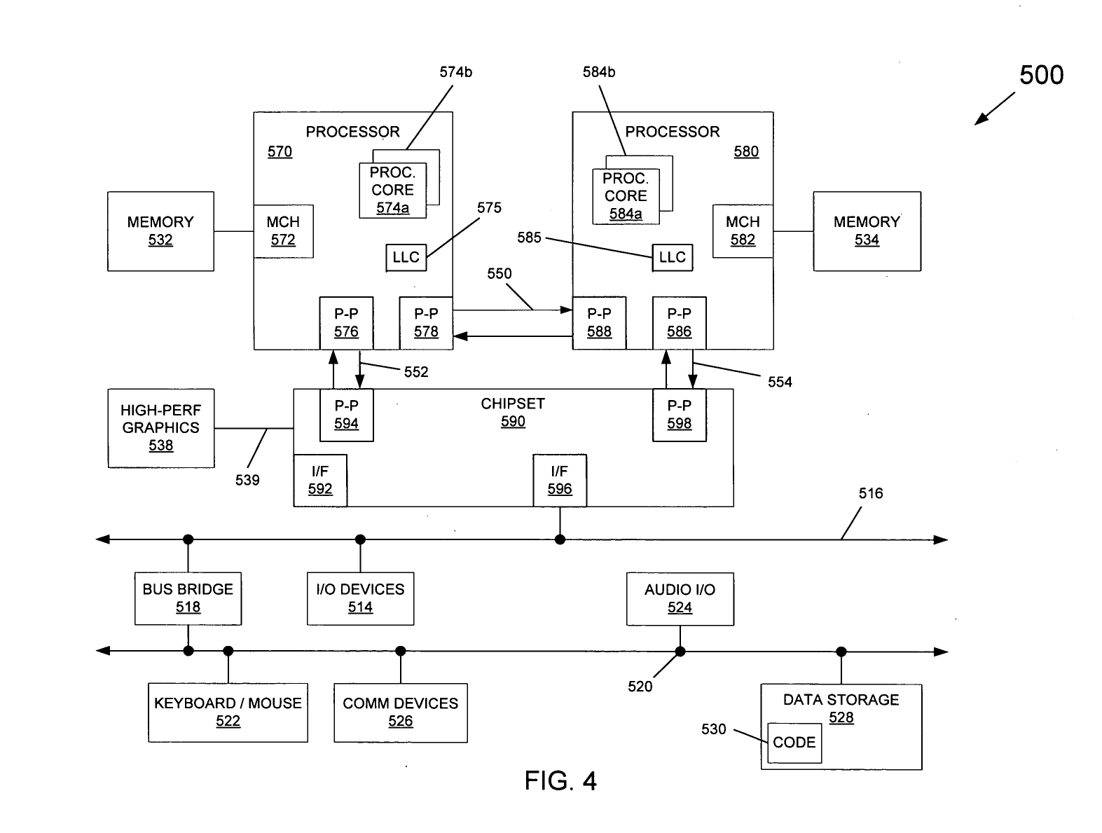

Referring now to FIG. 4, shown is a block diagram of a multiprocessor system in accordance with an embodiment of the present invention. As shown in FIG. 4, multiprocessor system 500 is a point-to-point interconnect system, and includes a first processor 570 and a second processor 580 coupled via a point-to-point interconnect 550. However, in other embodiments the multiprocessor system may be of another bus architecture, such as a multi-drop bus or another such implementation. As shown in FIG. 4, each of processors 570 and 580 may be multi-core processors including first and second processor cores (i.e., processor cores 574a and 574b and processor cores 584a and 584b), although other cores and potentially many more other cores may be present in particular embodiments, in addition to one or more dedicated graphics or other specialized processing engine. A last-level cache memory 575 and 585 may be coupled to each pair of processor cores 574a and 574b and 584a and 584b, respectively. To improve performance in such an architecture, a cache controller or other control logic within processors 570 and 580 (and I/O devices 514) may enable direct read and write communication between LLC's 575 and 585 and I/O devices 514, as described above.

Still referring to FIG. 4, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 4, MCH's 572 and 582 couple the processors to respective memories, namely a memory 532 and a memory 534, which may be portions of main memory (e.g., a dynamic random access memory (DRAM)) locally attached to the respective processors.

First processor 570 and second processor 580 may be coupled to a chipset 590 via P-P interconnects 552 and 554, respectively. As shown in FIG. 4, chipset 590 includes P-P interfaces 594 and 598. Furthermore, chipset 590 includes an interface 592 to couple chipset 590 with a high performance graphics engine 538. In one embodiment, an Advanced Graphics Port (AGP) bus 539 or a point-to-point interconnect may be used to couple graphics engine 538 to chipset 590.

In turn, chipset 590 may be coupled to a first bus 516 via an interface 596. In one embodiment, first bus 516 may be a PCI bus, as defined by the PCI Local Bus Specification, Production Version, Revision 2.1, dated June 1995 or a bus such as the PCI Express™ bus or another third generation I/O interconnect bus, although the scope of the present invention is not so limited.

As shown in FIG. 4, various I/O devices 514 may be coupled to first bus 516, along with a bus bridge 518 which couples first bus 516 to a second bus 520. In one embodiment, second bus 520 may be a low pin count (LPC) bus. Various devices may be coupled to second bus 520 including, for example, a keyboard/mouse 522, communication devices 526 and a data storage unit 528 which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving data from a producer input/output (I/O) device in a cache associated with a consumer without writing the data to a memory coupled to the consumer; and
storing the data in a first buffer of the cache until ownership of the data is obtained, and then storing the data in a cache line of the cache.

2. The method of claim 1, further comprising sending a completion message from the cache to the producer I/O device after storing the data in the cache line.

3. The method of claim 1, further comprising sending snoop requests from the cache to at least one other system agent to obtain the ownership of the data.

4. The method of claim 3, further comprising receiving the data with a direct memory write transaction and storing the data in a modified state of a cache coherency protocol.

5. The method of claim 4, wherein the direct memory write transaction comprises a non-coherent transaction.

6. The method of claim 1, further comprising accessing the data from the cache by a core coupled to the cache without incurring a cache miss.

7. The method of claim 1, further comprising:
determining in the producer I/O device a location of a cache line corresponding to the data in one of a plurality of caching agents via communication of snoop requests and receipt of responses thereto; and
sending the data to the one of the plurality of caching agents including the cache line for storage of the data into the cache line and setting of a modified state of a cache coherency protocol for the cache line.

8. An apparatus comprising:
a processor including a core and a cache memory coupled to the core, wherein the cache memory is to receive a request for a snapshot of data from a consumer and is to provide the data directly from the cache memory and without accessing a memory coupled to the processor and without changing a cache coherency state of the data;
the consumer coupled to the processor, wherein the consumer is to receive the data directly from the cache memory responsive to the request and without access to the memory and store the data in the consumer, the consumer corresponding to an input/output (I/O) device.

9. The apparatus of claim 8, wherein the cache memory is to provide the data responsive to the request regardless of the cache coherency state of the data, and is to further provide an identifier associated with the cache memory with the data provided to the consumer, the identifier to provide an indication of where the data came from.

10. The apparatus of claim 9, wherein the cache memory is to maintain the data in a modified cache coherency state after transmission of the data to the consumer.

11. The apparatus of claim 10, wherein the consumer is to store the data in a storage location of the consumer in an invalid cache coherency state.

12. The apparatus of claim 8, wherein the consumer is to request the data via issuance of a snapshot transaction to the processor and a snoop transaction to the cache memory.

13. The apparatus of claim 12, wherein the consumer is to request the data via a direct input/output (I/O) read transaction to cause issuance of the snapshot transaction from the consumer to a home agent associated with the processor.

14. The apparatus of claim 8, wherein the core is to copy the data from a cache line of the cache memory to a second location in the cache memory, and wherein the core is to perform an operation on the data in the second location.

15. The apparatus of claim 14, wherein the core is to send a cache line invalidate instruction to the cache memory after the data is copied to the second location to invalidate the data in the cache line without a writeback to the memory.
